(19) United States
(12) Patent Application Publication
(10) Pub. No.: US 2026/0089760 A1
(43) Pub. Date: Mar. 26, 2026

(54) RANDOM ACCESS CHANNEL TECHNIQUES FOR SUBSCRIBER IDENTITY MODULE

(71) Applicant: Apple Inc., Cupertino, CA (US)

(72) Inventors: Pranav Tripathi, San Jose, CA (US); Dhruv Khati, San Jose, CA (US); Sanjeevi Balasubramanian, San Jose, CA (US); Shiva Krishna Narra, Dublin, CA (US); Simran Arora, San Jose, CA (US)

(73) Assignee: Apple Inc., Cupertino, CA (US)

(21) Appl. No.: 18/896,106

(22) Filed: Sep. 25, 2024

(51) Int. Cl. H04W 74/0833

(52) U.S. Cl. CPC H04W 74/0833

(57) ABSTRACT

Techniques are described here for random access channel for techniques. An example method can include processing information indicating a first transmission power used to transmit a first random access channel (RACH) preamble to a base station, the first RACH preamble associated with a first subscriber identity model (SIM) of a device. The method can further include determining whether to use a second transmission power for transmitting a second RACH preamble or using an initial transmission power, the second RACH preamble associated with a second SIM of the device, the second transmission power based on the first transmission power, and the initial transmission power based on a path loss estimate associated with the second SIM. The method can further include determining to use the second transmission power for transmitting the second RACH preamble to the base station based on processing the information.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of an example environment for multi-subscriber identity model (SIM) random access channel (RACH), according to one or more embodiments.

FIG. 2 is an illustration of an example environment for a shared cell, according to one or more embodiments.

FIG. 3 is an illustration of an example environment for shared base stations, according to one or more embodiments.

FIG. 4 is an example process for determining a transmission power for a multi-SIM device, according to one or more embodiments.

FIG. 5 is an example process for determining a transmission power between two devices, according to one or more embodiments.

FIG. 6 is an illustration of an example data scenario, according to one or more embodiments.

FIG. 7 is an illustration of an example data scenario, according to one or more embodiments.

FIG. 8 is an illustration of example environments for device to device assistance, according to one or more embodiments.

FIG. 9 is an illustration of an example environment for device-to-device communication, according to one or more embodiments.

FIG. 10 is an illustration of an example user interface, according to one or more embodiments.

FIG. 11 is an illustration of an example user interface, according to one or more embodiments.

FIG. 12 is an illustration of an example user interface, according to one or more embodiments.

FIG. 13 is an illustration of an example of receive components, in accordance with some embodiments.

FIG. 14 is an illustration of an example of a user equipment (UE), in accordance with some embodiments.

FIG. 15 is an illustration of an example of a network node, in accordance with some embodiments.

### DETAILED DESCRIPTION

A user equipment (UE) can use a random access channel (RACH) procedure to establish a connection with a network, request resources from the network, and synchronize timing with the network. The UE can transmit a preamble to a base station over a RACH resource to request access to the network. If the UE does not receive a response, the UE can increase the transmission power and retry sending the RACH preamble to the base station. If the UE again does not receive a response, it can continue ramping up the transmission power and retransmitting the RACH preamble up to a maximum transmission power. Assuming that a RACH preamble transmission is successful at a certain transmission power, the base station can transmit a RACH response back to enable the UE to connect with a network.

In some instances, a UE can be a multi-subscriber identity module (SIM) device, that can use multiple SIMs. The operations for one SIM can affect the operations for the other SIM. For example, in a single receive (SR)-dual SIM dual standby (DSDR) or a dual receive (DR-DSDR) scenario, transmission or reception activity on one SIM can suspend ongoing activities on the other SIM due to the SIMs having to share resources. In the case that one SIM has to transmit data, the other SIM's activities are throttled as a UE cannot transmit on one SIM and simultaneously transmit or receive on the other SIM. This can increase the latency for a UE that is performing different operations for different SIMs.

One challenge for multi-SIM devices is that each SIM can transmit an initial RACH preamble using the same initial transmission power. For example, a UE transmits an initial RACH preamble with respect to a first SIM at an initial transmission power (e.g., 4 decibel milliWatt (dBm)). The initial RACH preamble is unsuccessful and the UE ramps up the power until the RACH procedure is successful. Later if the UE needs to perform another RACH procedure for the second SIM, the UE again sends an initial RACH preamble at the same initial transmission power. Given that the UE was unsuccessful transmitting the RACH preamble at the initial transmission power for the first SIM and given that the two SIMs are co-located (e.g., the same or substantially similar propagation paths exist between them and the base station), it is likely that the UE will be unsuccessful transmitting the RACH preamble at the initial transmission power for the second SIM. The UE will ramp up the power for each successive RACH preamble transmission until it is successful. The time used to ramp up the transmission power for the second SIM can increase the overall latency for the UE.

The embodiments herein address the above-referenced issues by describing techniques for a UE to use information determined from a RACH procedure for a first SIM for a RACH procedure for a second SIM. In particular, the UE can determine the transmission power used for a successful RACH preamble transmission for the first SIM. In the event that the second SIM is to connect with the network, the UE can use the transmission power to determine a starting transmission power to transmit a RACH preamble for the second SIM. Therefore, the UE may use the information to skip one or more transmission power ramping steps and transmit a RACH preamble for the second SIM at a transmission power that is based on the successful transmission power for the first SIM.

In the interest of clarity, various embodiments are described with two SIMs of a same UE. The SIMs can be considered to be co-located. However, the embodiments are not limited as such. For example, the embodiments similarly and equivalently apply to multiple SIMs of the same UE. Likewise, the embodiments similarly apply to two or more devices that are co-located (where any of these devices can include one or more SIMs). Co-located can include having the same or substantially similar propagation paths to a base station. Substantially similarity can be defined in a technical specification and can be quantified by using a channel response, transmission power, reception power, propagation delay, line of sight, Doppler effect, and/or other radio frequency (RF) properties. Additionally, or alternatively, the propagation paths can be assumed to be substantially similar or the same when the two devices co-located (e.g., within a predefined threshold distance of each other (e.g., ten feet)) and use similar RF channel properties (e.g. the same radio access technologies (RATs) and the same frequency bands or frequency bands that are within a predefined frequency range of each other). When the devices are co-located, the first transmission power used by one device for a successful RACH can be determined. The second transmission power to be used by another co-located device for its RACH transmission can be based on the first transmission power.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network.

Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “connected” may mean that two or more elements, at a common communication protocol layer, have an established signaling relationship with one another over a communication channel, link, interface, or reference point.

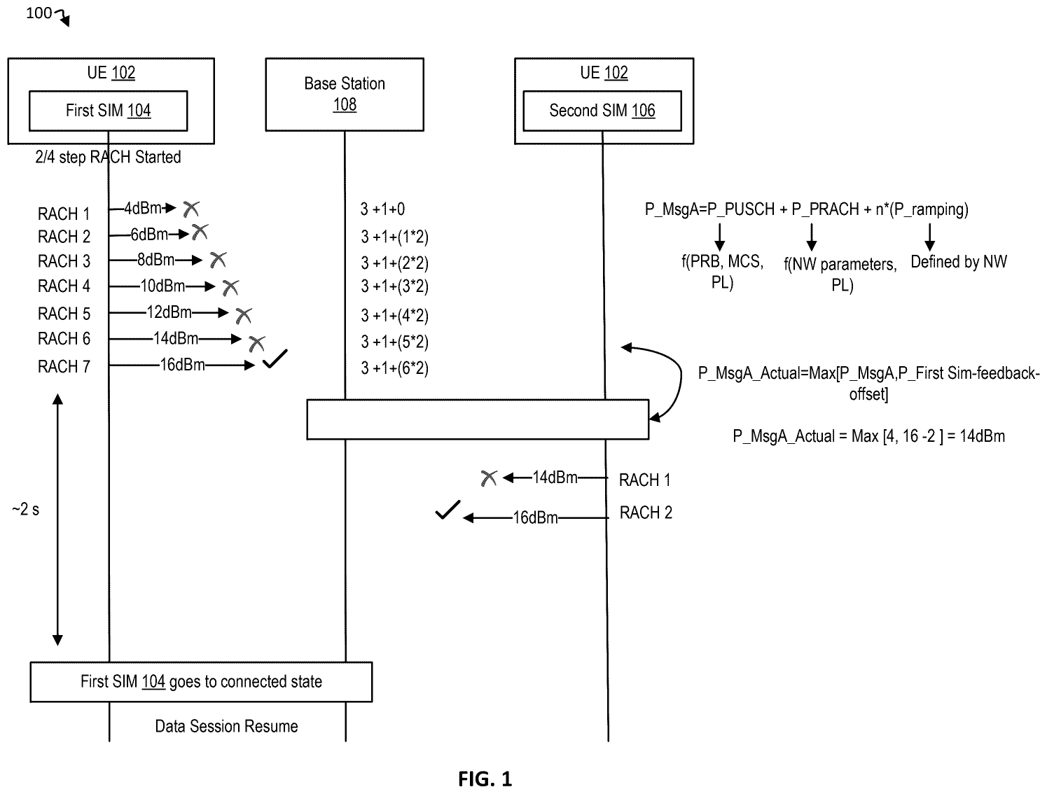

FIG. 1 is an illustration of an example environment for multi-SIM RACH, according to one or more embodiments. A user equipment (UE) 102 can include a first subscriber identification module (SIM) 104 (e.g., a default data subscriber (DDS)) and a second SIM 106 (e.g., non-DDS (nDDS). Each of the first SIM 104 and the second SIM 106 can be used, for example, for identification of a user account, authentication of a user account, and storage of information. The first SIM 1104 and the second SIM 106 can be associated with the same network or different networks. It should be appreciated that although the first SIM 104 and the second SIM are separated in FIG. 1, this is for illustrative purposes. The UE 102 can simultaneously store the first SIM 104 and the second SIM 106.

As indicated above, the UE 102 can use the first SIM 104 for performing a RACH procedure. The UE 102 can determine a starting power for transmitting the first RACH preamble. For example, a network, via the base station 108, can transmit system information blocks (SIBs) that include parameters to be used in a RACH procedure. The UE 102 can further estimate a path loss for a signal from the base station 108. For example, the UE 102 can estimate the path loss based on a reference signal (RS). As an example, in FIG. 1 the starting transmission power for the first RACH preamble (RACH 1) is 4 dBm.

In some instances, the first RACH preamble transmission is unsuccessful. For example, the UE 102 may not process a RACH response message from the base station 108. In these instances, the UE 102 can incrementally ramp up the transmission power for a subsequent RACH preamble message. The UE 102 can be configured by the network with steps to determine the incremental increase in power transmission. An example formula inlcudes:

$$P\_MsgA = P\_PUSCH + P\_PRACH + n * ( P\_ramping ) , \qquad ( 1 )$$

where a P_MsgA value is the transmission power; a P_PUSCH value is a function of a physical resource block (PRB) value, a modulation and coding scheme (MCS) value, and a path loss value; a P_PRACH value is a function of network parameters and a path loss value; n is a number of previous RACH preamble transmission attempts, and P_ramping value is an incremental transmission power increase.

As illustrated in FIG. 1, the UE 102 can determine to incrementally increase each subsequent RACH preamble transmission attempt by 2 dBm. The UE 102 can continue to increase the transmission power for subsequent RACH preamble transmissions until it is successful. For example, the UE 102 can continue to increase the transmission power unit it processes a RACH response message from the base station 108. For example, in FIG. 1, the UE 102 incrementally increased the transmission power to 16 dBm before it was successful.

After the successful RACH preamble transmission using information from the first SIM 104, the UE 102 may transmit a RACH preamble using information from the second SIM 106. In a conventional multi-SIM device, the UE 102 can perform the same steps to determine a starting transmission power as used in connection with the first SIM 104. Both SIMs are in the same device and a path loss estimation is likely to result in the same value for the second SIM 106 as the first SIM 104. Therefore, for a conventional multi-SIM device, it is likely that the conventional multi-SIM device would determine the same starting transmission power for the second SIM 106 as the first SIM 104.

By starting at the same transmission power for a RACH preamble using information from the second SIM 106 as the first SIM 104 can introduce latency into the UE's operations. As illustrated in FIG. 1, the UE 102 performed six unsuccessful RACH preamble attempts before a successful seventh RACH preamble transmission. After each RACH attempt, the UE 102 waits for a period of time for a RACH response message from the base station 108. Therefore, the UE 102 waited six times for a RACH response message before transmitting the successful RACH preamble at 16 dBm.

As described herein, the UE 102 can use the information obtained from the RACH preamble attempts for the first SIM 104 to determine the starting transmission power for a RACH preamble for the second SIM 106. As illustrated, the UE 102 successfully transmitted a RACH preamble for the first SIM 104 at a transmission power of 16 dBm. Therefore, rather than starting at baseline transmission power (e.g., 4 dBm), the UE 102 can use the information obtained from the successful transmission of the RACH preamble for the first SIM 104 to set the starting transmission power for the second SIM 106. The UE 102 can be configured to select a candidate starting transmission power at the same transmission power (e.g., 16 dBm) used to transmit the successful RACH preamble for the first SIM 104. In some embodiments, the UE 102 can determine an offset to be applied to the candidate starting transmission power. The UE 102 can reduce the candidate starting transmission power by the offset. In this sense, the offset can allow the UE 102 to conserve power by transmitting the RACH preamble for the second SIM 106 at less than the transmission power used to transmit the successful RACH preamble for the first SIM 104. As illustrated in FIG. 1, the UE 102 has determined an offset of 2 dBm and transmitted a RACH preamble for the second SIM 106 at 14 dBm. As further illustrated, this RACH preamble was unsuccessful and the UE 102 incrementally increased the transmission power to 16 dBm for a second RACH preamble transmission. As illustration, the second RACH preamble transmission was a successful transmission.

A formula for determining the transmission power for the second SIM 106 is provided in FIG. 1 as follows:

$$P\_MsgA \_Actual = Max [ P\_MsgA , P\_FirstSim \_feedback - offset ] , \qquad ( 2 )$$

where P_MsgA_Actual is the value of the transmission power for the RACH preamble transmission for the second SIM 106; P_MsgA is the value of the starting transmission power for the first SIM 104 (e.g., 4 dBM); and P_FirstSim_feedback is the value of the transmission power for the successful RACH preamble for the first SIM 104 (e.g., 16 dDm); and offset is the value of the offset (e.g., 2 dBm). The UE 102 can select between the maximum of P_MsgA and P_FirstSim_feedback-offset. Therefore, if P_MsgA was a greater transmission power (e.g., 16 dBm) than the P_FirstSim_feedback-offset (e.g., 14 dBm), the UE 102 could determine to use P_MsgA as the starting transmission power for the second SIM 106. It is possible that in some instances, the UE 102 started at a maximum transmission power to transmit the RACH preamble for the first SIM 104. In these instances, the UE 102 can start with the maximum transmission power. In some instances, the first SIM 104 is unsuccessful at a RACH preamble transmission while using a maximum allowable transmission power. In these instances, the UE 102 can start a PRACH procedure using the maximum allowable transmission power for the second SIM 106.

It should be appreciated that the UE 102 may not determine the offset to be the same value as the incremental increase value (e.g., 2 dBM). Rather various factors, including a time interval between the successful RACH preamble transmission, frequency band, device type, network configuration of the offset, and other appropriate factors can be used to determine the offset. In some instances, a path loss estimate by the UE 102 is greater than a threshold pass loss estimate (e.g., 2 dB). In these instances, the UE 102 or the network can modify the offset based on the path loss estimate being greater than the threshold path loss estimate.

As illustrated, the first SIM 104 can enter a connected state after the successful RACH preamble transmission. For example, the UE 102 can enter the connected state approximately 2 seconds after the successful RACH preamble transmission. Furthermore, the UE 102 can have sent the successful RACH preamble for the second SIM 106 prior to the first SIM 104 entering a connected state. This is different than a conventional system, in which the UE 102 determines the starting power transmission level the same for the second SIM 106 as for the first SIM. For example, the delay between the successful RACH preamble transmission and the first SIM 104 entering a connected state can be 7 to 10 seconds, as the UE 102 would incrementally ramp up the powers by 2 dBm from 4 dBm to 16 dbM for the second SIM 106 as it did for the first SIM 104. Using these techniques, the UE 102 can save power and battery life by not having the second SIM 106 transmit RACH preambles at each of the powers of the first SIM 104. The second SIM 106 can camp faster and allocate resources to the first SIM 104. Furthermore, the first SIM's data session can resume faster result in a better user experience.

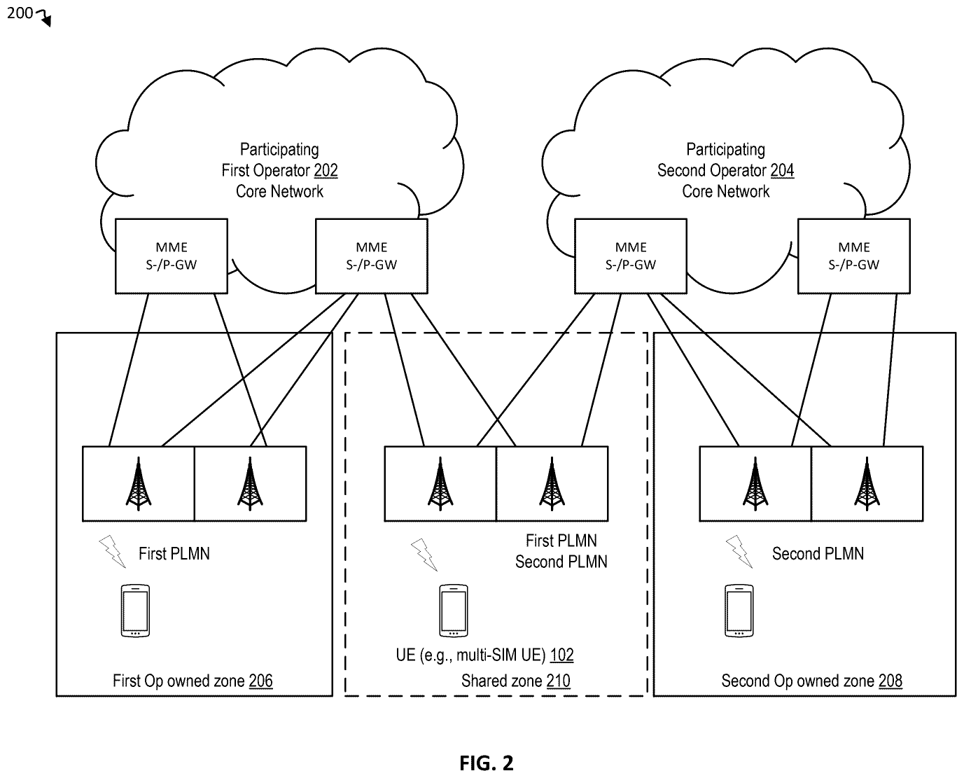

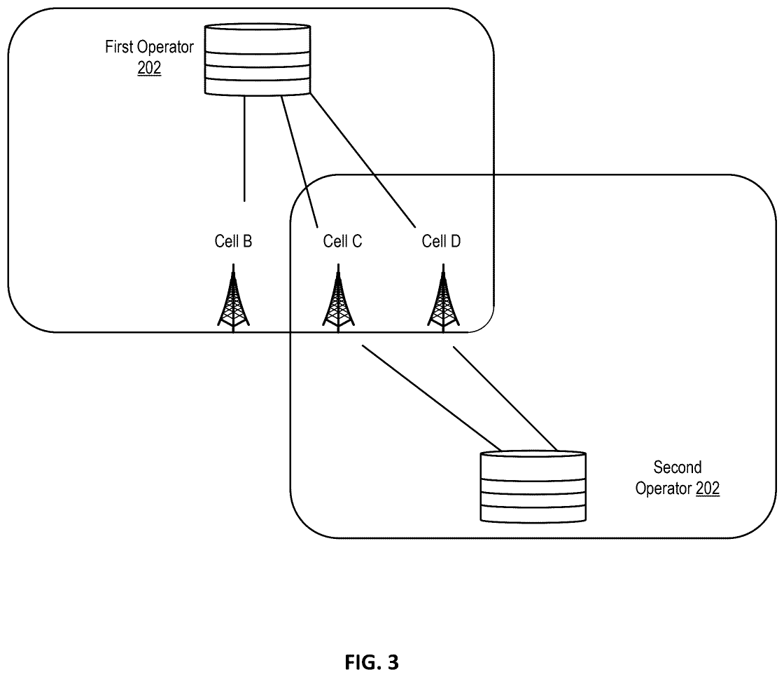

In some instances, a cell can be shared by more than one network operator. The UE 102 can determine whether a cell is shared based on decoding a system information block (SIB) (e.g., SIB1). For example, if the SIB only indicates a single public land mobile network (PLMN) in the information element (IE) PLMN-IdentifyInfoList, a cell is not a shared cell between different network operators. If, the SIB indicates more than one PLMN, then the cell is a shared cell. FIGS. 2 and 3 are provided to describe instances in which a cell is shared by more than one network operator.

FIG. 2 is an illustration 200 of an example environment for a shared cell, according to one or more embodiments. As illustrated, a first operator 202 and a second operator 204 can be connected to base stations via serving gateways/packet data network gateways (S/P-GWs). The first operator 202 can provide services for a first operator owned zone 206, and without the second operator 204. The second operator 204 can provide services for a second operator owned zone 208, and without the first operator 202. Both the first operator 202 and the operator 204 can provide services in a shared zone 210. A UE 102 can process a SIB message and determine that a first PLMN (e.g., first operator 202) and a second PLMN (e.g., second operator 204) are indicated in the SIB. In some instances, the UE 102 is a multi-SIM UE and includes a first SIM associated with the first operator 202 and a second SIM associated with the second operator 204. As both operators are providing services in a shared cell, it can be assumed that the path loss estimates for signals from each operator will be the same, or essentially equivalent (e.g., one path loss estimate is within 1 dB of another path loss estimate). FIG. 1 can relate to instances, in which the first SIM 104 and the second SIM 106 are associated with a same network operator. FIG. 2 can relate to instances, in which a first SIM (e.g., DDS) is associated with the first operator 202 and the second SIM (e.g., nDDS) is associated with the second network operator 204. Furthermore, as illustrated, each of the first operator 202 and the second operator 204 can share a base station to provide services via a shared cell.

The UE 102 can use the same techniques for determining a transmission power for a RACH preamble for the first SIM and the second SIM as described with respect to FIG. 1. For example, the UE 102 can determine a transmission power for a RACH preamble for the first SIM using equation 1 from above. If the RACH preamble transmission is not successful, the UE 102 can incrementally increase the transmission power until the RACH preamble transmission is successful.

The UE 102 can further use information obtained via connecting the first SIM to a network (e.g., a network controlled by the first operator 202 or a network controlled by the second operator 204) to determine a transmission power for RACH transmission for the second SIM. For example, the UE 102 can determine P_MsgA_Actual using equation 2 from above. The UE 102 can determine the offset based on various factors, (e.g., a time interval between the successful RACH preamble transmission, device type, frequency band, network configuration of the offset, and other appropriate factors). For example, the UE 102 can determine an offset based on whether a frequency band used to transmit a first RACH preamble is a same frequency band as to be used to transmit a second RACH preamble. The second transmission power can be based on the offset. In another example, the UE 102 can determine an offset based on comparing the path loss estimate to the threshold path loss estimate. The second transmission power can be based on the offset. In some instances, a path loss estimate by the UE 102 is greater than a threshold pass loss estimate. In these instances, the offset can be modified based on the path loss estimate being greater than the threshold path loss estimate.

As with FIG. 1 above, it is possible that in some instances, the UE 102 started at a maximum transmission power to transmit the RACH preamble for the first SIM. In these instances, the UE 102 can start with the maximum transmission power for the second SIM. In some instances, the first SIM is unsuccessful at a RACH preamble transmission while using a maximum allowable transmission power. In these instances, the UE 102 can start a PRACH procedure using the maximum allowable transmission power for the second SIM.

FIG. 3 is an illustration 300 of an example environment for shared cells, according to one or more embodiments. As illustrated the first operator 202 and the second operator 204 can be connected to different base stations that provide different cells (e.g., cell B, cell C, and cell D). Cell B is provided by the first operator 202, and without the second operator 204. Cell C and cell D are shared cells that are provided by both the first operator 202 and the second operator 204. A UE 102 (e.g., multi-SIM UE) can use the techniques described with respect to FIG. 1 to connect with the cell B for both a first SIM (e.g., first SIM 104) and a second SIM (e.g., second SIM 106) in which both SIMs are associated with the same operator. A UE 102 (e.g., multi-SIM UE) can use the techniques described with respect to FIG. 2 to connect with either cell C or cell D for both a first SIM (e.g., first SIM 104) and a second SIM (e.g., second SIM 106) in which each SIM is associated with a different operator.

As indicated above, the UE 102 can transmit a RACH preamble for a 4 step RACH procedure or a 2 step RACH procedure. For a 4 step RACH procedure, the UE (e.g., UE 102) can transmit the RACH preamble (e.g., first message) to a base station (e.g., base station 108). The base station can transmit a random access response to the UE. The RACH response can include timing advance (TA) information, an uplink (UL) resource allocation, and a temporary cell radio network temporary radio network identifier (C-RNTI) (e.g., second message). The UE can then transmit a scheduled transmission using the UL resource allocation to the base station (e.g., third message). The base station can then send a second RACH response (e.g., fourth message) that includes a contention resolution message to the UE.

In a 2 step RACH procedure, the first message and the third message can be combined, and the second message and the fourth message can be combined. In a first step, the UE can transmit a RACH preamble and data over a physical uplink shared channel (PUSCH) to a base station. In a second step, the base station can transmit a random access response that includes TA information, UL resource allocation information, C-RNTI, and contention resolution information. Ut should be appreciated that the herein described techniques can be used for a 4 step RACH procedure or a 2 step RACH procedure.

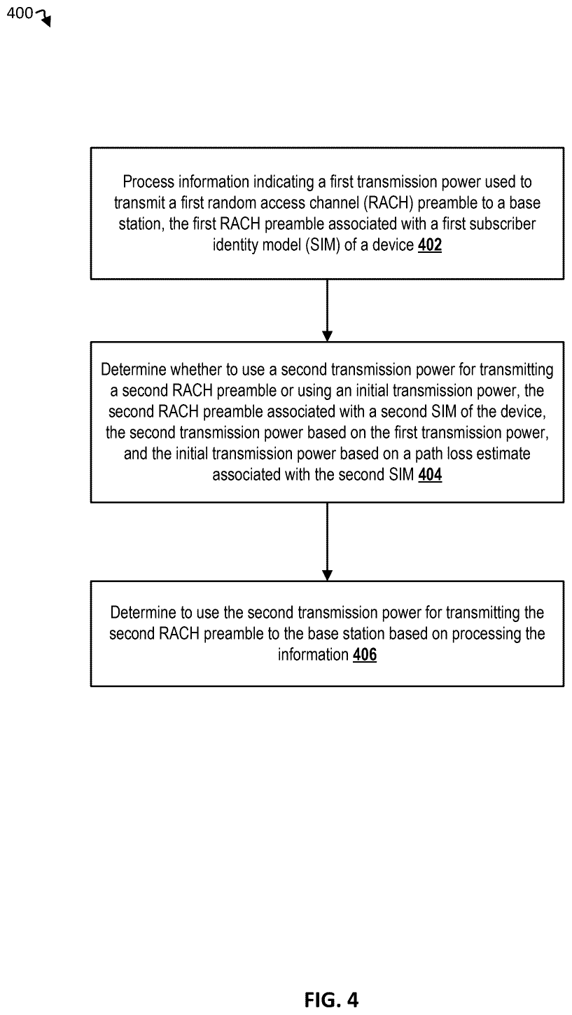

FIG. 4 is an example process 400 for determining a transmission power for a multi-sim device, according to one or more embodiments. At 402, the process can include an apparatus of a UE (e.g., UE 102) processing information indicating a first transmission power used to transmit a first random access channel (RACH) preamble to a base station. The first RACH preamble can be associated with a first subscriber identity model (SIM) (e.g. first SIM 104) of a device (e.g., UE 102).

At 404, the process 400 can include the apparatus determining a second transmission power for a second RACH preamble associated with a second SIM (e.g., second SIM 106) of the device. The second transmission power can be based on the first transmission power. For example, the apparatus can use equation 1 from above to determine the transmission power for the first RACH preamble for the first SIM. The apparatus can then use equation 2 from above to determine the transmission power for the second SIM.

At 406, the process 400 can include the apparatus determining whether to use a second transmission power for transmitting a second RACH preamble or using an initial transmission power. The second RACH preamble can be associated with a second SIM of the device. The second transmission power can be based on the first transmission power. The initial transmission power can be based on a path loss estimate associated with the second SIM.

The above described techniques can be used for a multi-SIM device and for device to device instances. For example, two UEs that are in close proximity to each other UE can generally experience similar channel loss conditions, path loss, and other transmission characteristics. Therefore, the techniques herein can be used by one UE to use information obtained by another UE to determine a transmission power for a RACH preamble.

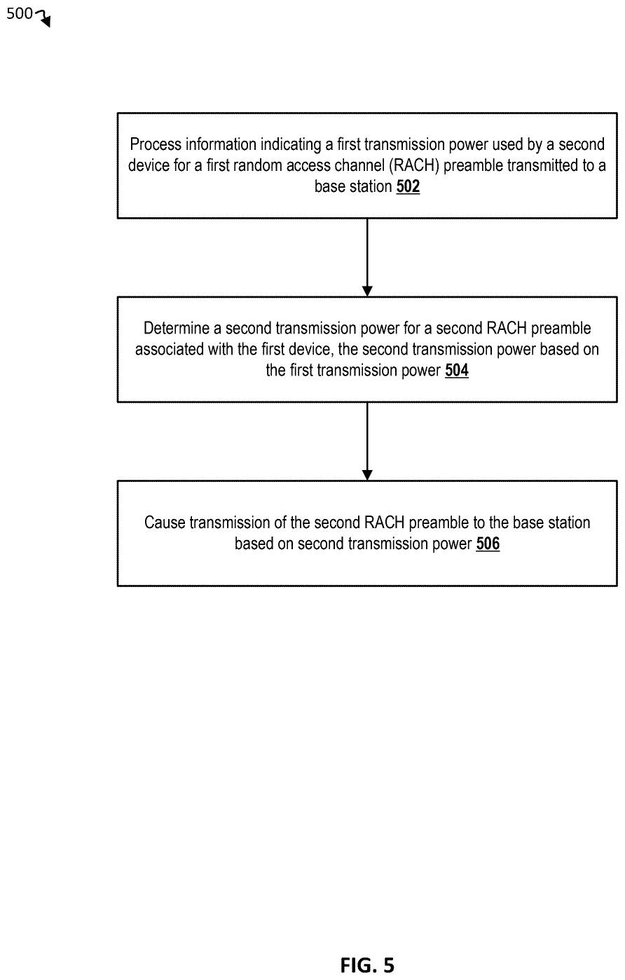

FIG. 5 is a process 500 for determining a transmission power between two devices, according to one or more embodiments. At 502, the process 500 can include an apparatus of first device processing information indicating a first transmission power used by a second device for a first random access channel (RACH) preamble transmitted to a base station. The two devices can be in proximity to each other and experience the same transmission characteristics. The second UE can have successfully transmitted a RACH preamble to a base station. The first UE and the second UE can communicate to provide the first UE with the transmission power used to successfully transmit the RACH preamble by the second UE.

At 504, the process 500 can include the apparatus determining a second transmission power for a second RACH preamble associated with the first device, the second transmission power based on the first transmission power. For example, the second device can use equation 1 from above to determine the transmission power for the first RACH preamble. The apparatus can then use equation 2 from above and information from the second device to determine the transmission power for the second SIM.

At 506, the process 500 can include the apparatus causing transmission of the second RACH preamble to the base station based on second transmission power. Using the herein described techniques, the first device can conserve power and battery life. In addition, the first device and the second device can reduce the latency for engaging in a data session.

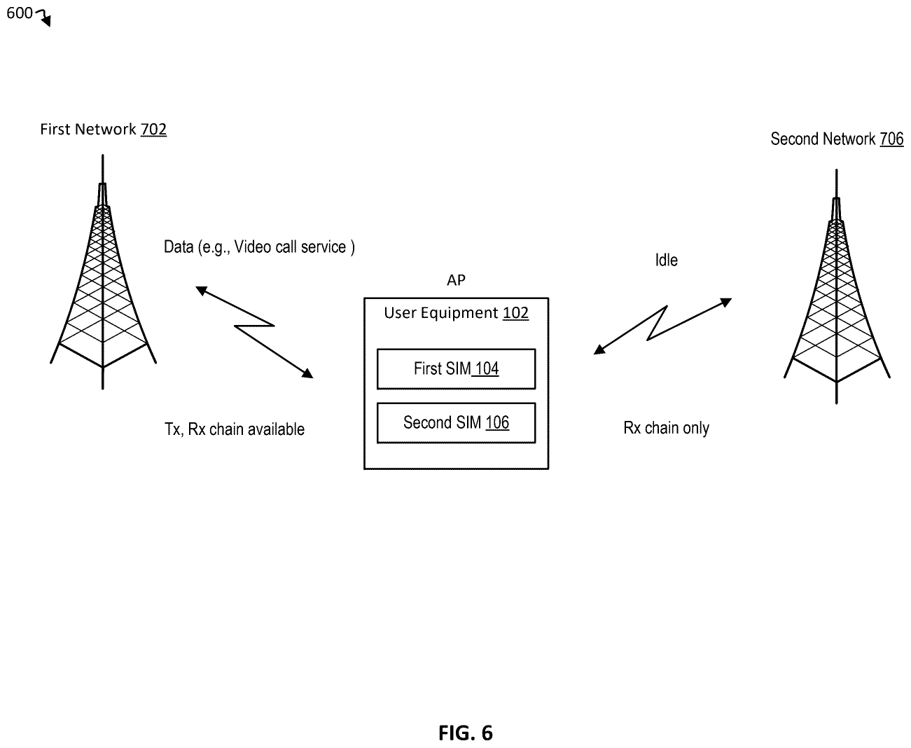

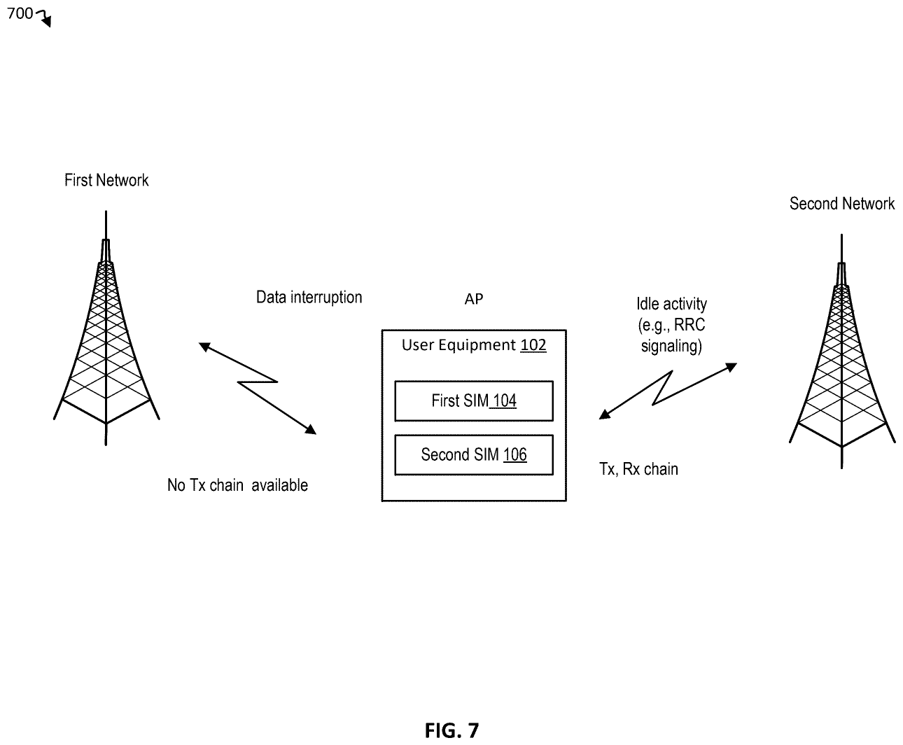

FIGS. 6 and 7 can be viewed collectively. As indicated above, if one SIM is transmitting, the other SIM may not be able to transmit or receive. Therefore, while the UE is transmitting (e.g., RACH preambles) for one SIM, the other SIM may suspend data activity.

FIG. 6 is an illustration 600 of an example data scenario, according to one or more embodiments. A UE 102 can include a first SIM 104 connected to a first network 702 (e.g., first operator 202) and a second SIM 106 connected to a second network 706 (e.g., second operator 204). The first SIM 104 can be a DDS. The first network 702 can allocate resources for reception and transmission to be used by the first SIM 104. In some instances, the first SIM 104 may use the resources for an application, such as a video call service or other application. The second SIM 106 may be in an idle mode and the second network 704 may have allocated resources for reception to be used the second SIM 106.

FIG. 7 is an illustration 700 of an example data scenario, according to one or more embodiments. The second network 706 may allocate resources for transmission and reception to be used by the second SIM 106. The second SIM 106 may use the resources for a transmission (e.g., signaling, measurement, reporting, or other transmission). If the second SIM 106 is transmitting, the data activity (e.g., voice call service) of the first SIM 104 may be interrupted. The first SIM 104 may suspend the data activity (e.g., voice call service). The suspension of the data may last for a time interval (e.g., six to ten seconds) and can be characterized as a data stall.

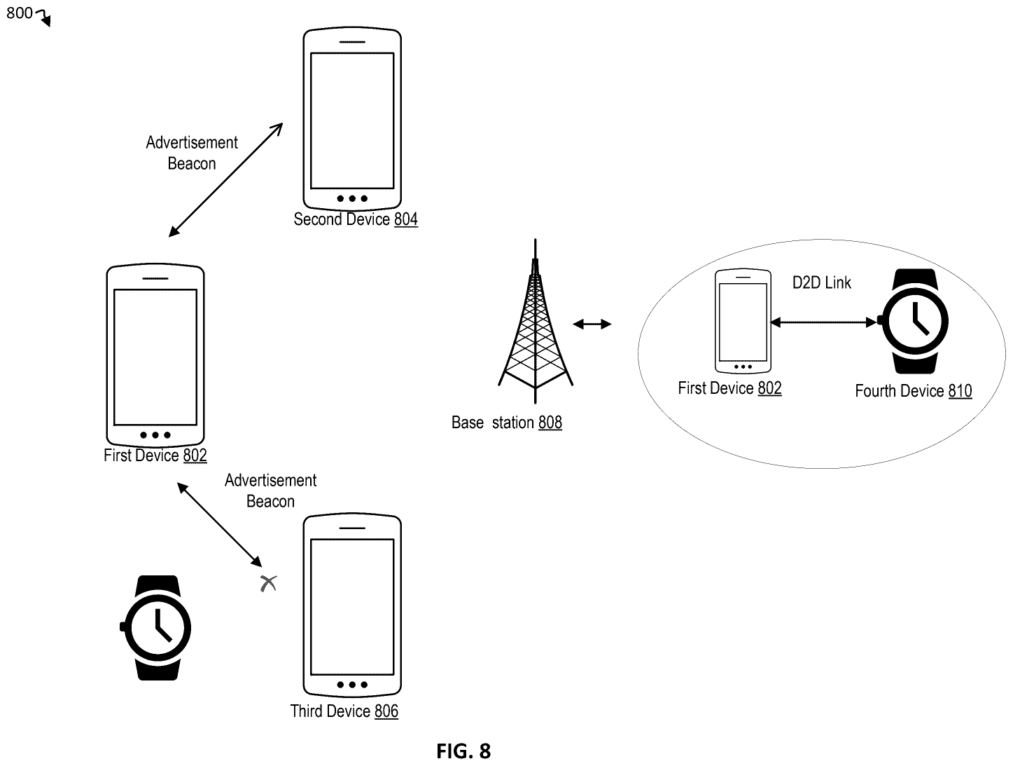

FIG. 8 is an illustration of an example environments for device to device assistance, according to one or more embodiments. A first device 802, a second device 804, and a third device 806 can include advertising beacons for broadcasting signals. Each other device can measure a signal strength (e.g., received signal strength indicator (RSSI) of the others device's broadcasts. For example, the devices can determine that other devices with stronger signals are closer in proximity. Various techniques can be used to determine the proximity of the devices to each other. Each device can compare a distance to another device to a threshold distance. As illustrated, the first device 802 can determine that the second device 804 is within a threshold distance, but that the third device 806 is not within the threshold distance.

For devices that are within the threshold distance, the service can enable the devices to establish a device-to-device link and share information with themselves and the network. For example, a first device 802 can be connected to a base station 808 of a network, and connected to a fourth device via a device-to-device link. The device-to-device link can be used share information, such as RACH transmission power information, SIB network parameters, ghost cell information, best cell information, beam information, congestion mitigation path (e.g., avoid cel X_x) information, mobility information for targeting a cell, and other appropriate information.

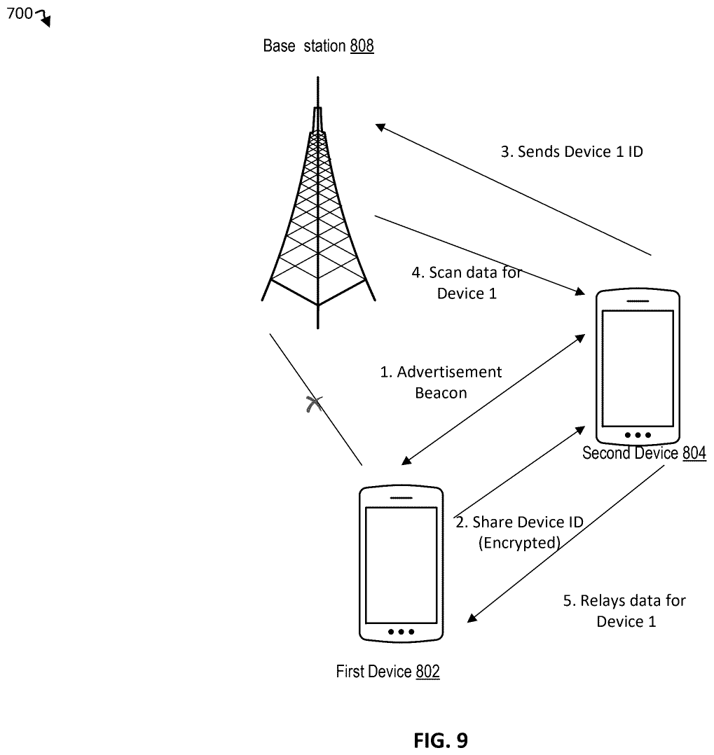

FIG. 9 is an illustration of an example environment for device-to-device communication, according to one or more embodiments. In some instances, a device linked to another device can experience issues (e.g., thermal trap, low battery, physical damage, or other issue). Issue information can be communicated to a linked device explicitly or implicitly determined by the linked device. In these instances, the linked device can communicate with the network to provide information as to the issue. The network can use this information to apply corrective measures for the device experiencing issues.

For example, a first device 802 and a second device 804 can broadcast advertisements indicating that they are in proximity of each other. Based on the proximity, the first device 802 can share a device identifier with the second device 804. In some instances, the device identifier can be in encrypted format. The second device 804 can transmit the device identifier to a base station 808. The base station 808 can transmit data for the first device 802 to the second device 804. The second device 804 can relay the data from the base station 808 to the first device 802. Therefore, even if the first device 802 is experience issues, the second device 804 can assist with communications between the base station 808 and the first device 802.

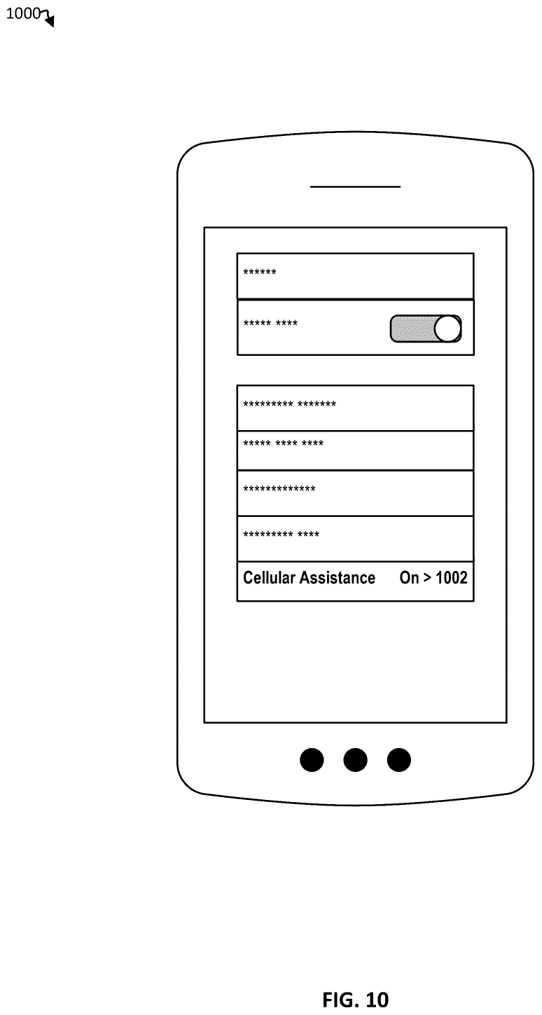

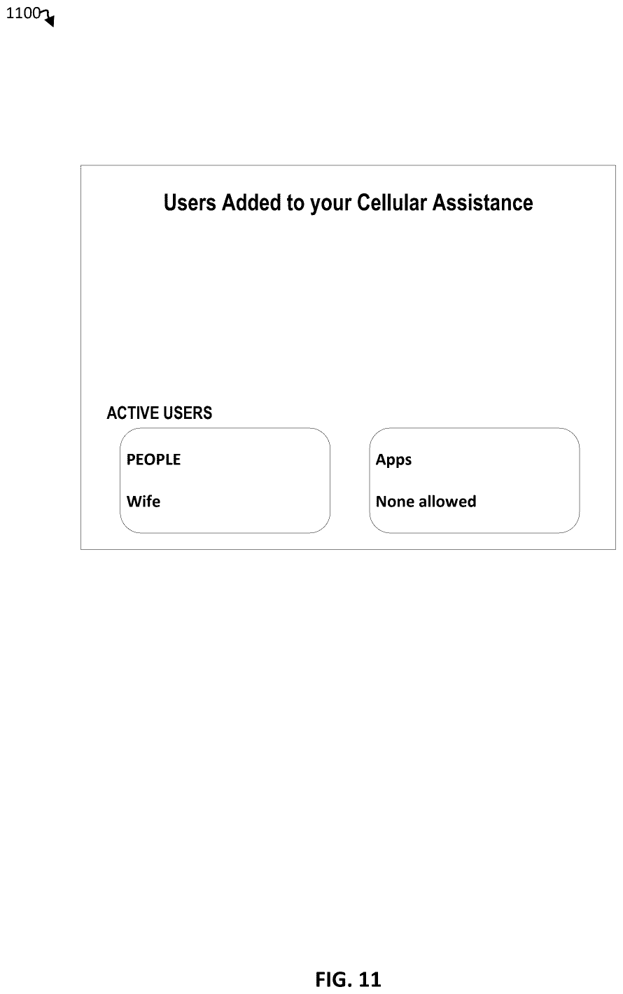

FIGS. 10, 11, and 12 are illustrations of various user devices or user interfaces used to implement the functionality described above. FIG. 10 is an illustration 1000 of an example user device, according to one or more embodiments. FIG. 11 is an illustration 1100 of an example user interface, according to one or more embodiments. A user device can be enabled to permit device-to-device assistance by receiving an input that the device-to-device feature 1002 has been enabled. In some instances, the device-to device feature 1002 can be restricted to particular other user devices. For example, the device-to-device feature can be restricted to other devices in a user device's network, devices associated with accounts known to the user device, or other appropriate restriction. As illustrated, the user interface indicates that the only device that communicate with the user device is the user's wife's device.

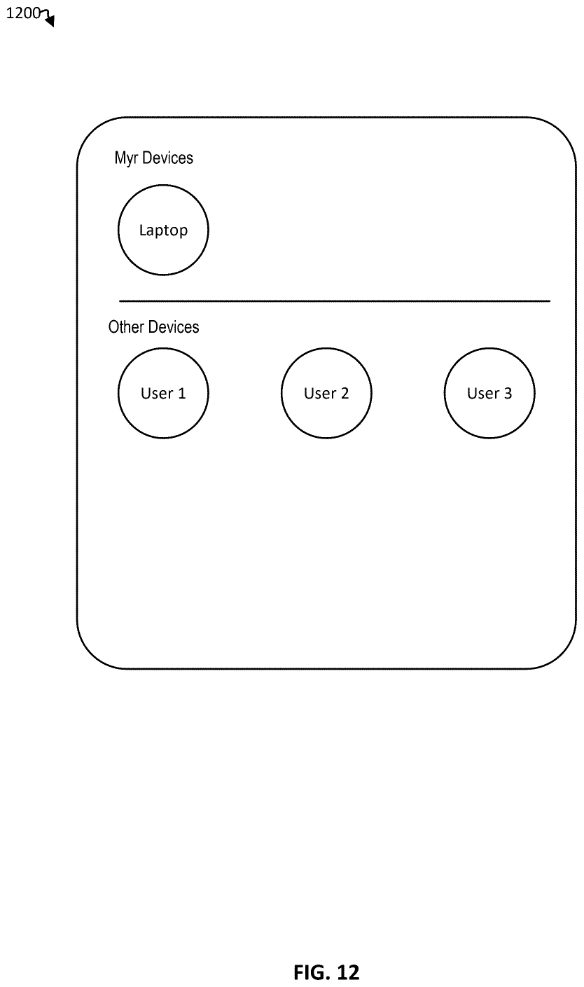

FIG. 12 is an illustration 1200 of an example user interface, according to one or more embodiments. As illustrated, a user device can display are user devices that are in proximity. The user device can then receive inputs (e.g., user-based inputs) as to which devices can communicate via a device-to-device service. By enabling a UE to receive assistance from other devices and the network, the UE can continue to function with good service, even if it is experiencing issues.

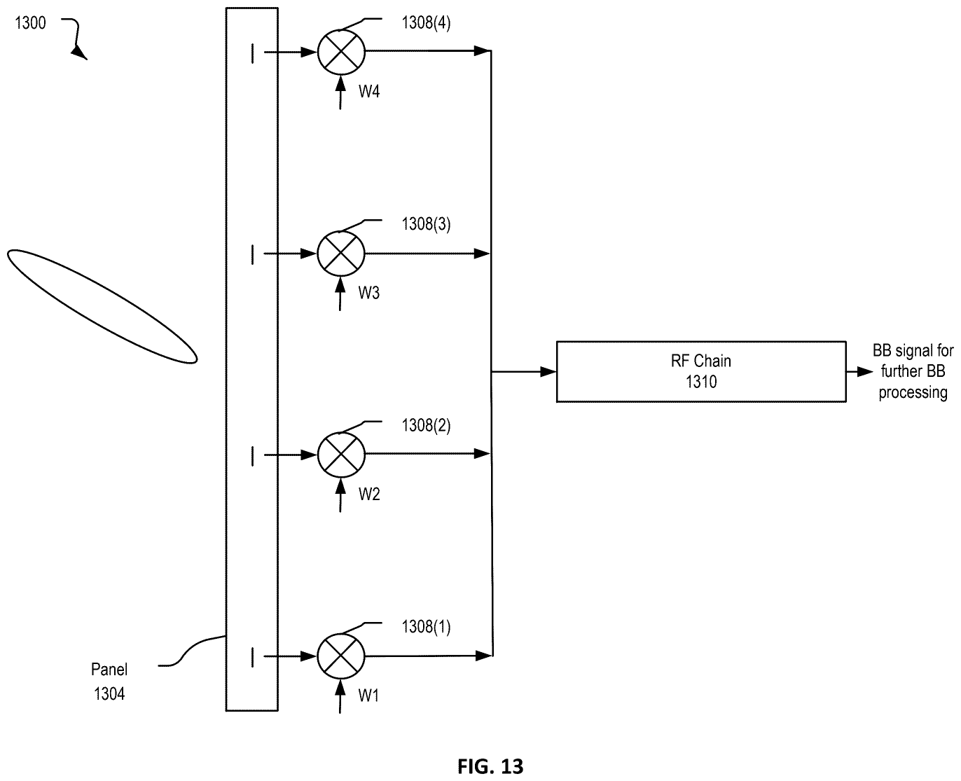

FIG. 13 illustrates receive components 1300 of the UE 1306, in accordance with some embodiments. The receive components 1300 may include an antenna panel 1304 that includes a number of antenna elements. The panel 1304 is shown with four antenna elements, but other embodiments may include other numbers.

The antenna panel 1304 may be coupled to analog beamforming (BF) components that include a number of phase shifters 1308(1)-1308(4). The phase shifters 1308(1)-1308(4) may be coupled with a radio-frequency (RF) chain 1313. The RF chain 1313 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1308(1)-1308(4) to provide a receive beam at the antenna panel 1304. These BF weights may be determined based on the channel-based beamforming.

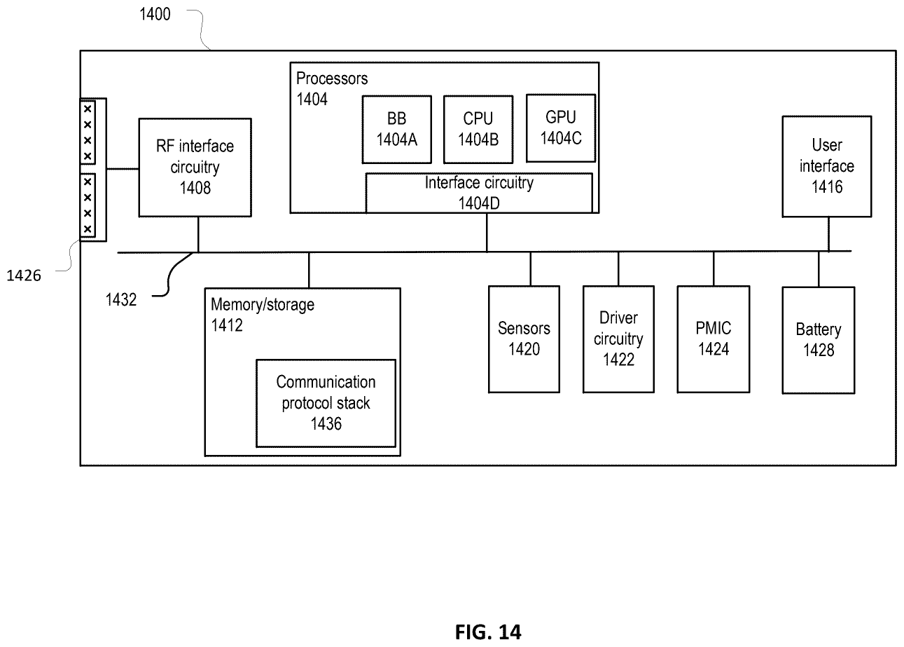

FIG. 14 illustrates a UE 1400, in accordance with some embodiments. The UE 1400 may be similar to and substantially interchangeable with UE 102 of FIG. 1.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform delay-adaptive operations as described herein. The processors 1404 may also include interface circuitry 1404D to communicatively couple the processor circuitry with one or more other components of the UE 1400. The processors 1404 can be configured to determine a transmission power for a RACH preamble.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack 1436 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various delay-PRACH operations described herein.

The memory/storage 1412 includes any type of volatile or non-volatile memory that may be distributed throughout the UE 1400. In some embodiments, some of the memory/storage 1412 may be located on the processors 1404 themselves (for example, memory/storage 1412 may be part of a chipset that corresponds to the baseband processor circuitry 1404A), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

A battery 1428 may power the UE 1400, although in some examples the UE 1400 may be mounted deployed in a fixed location and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

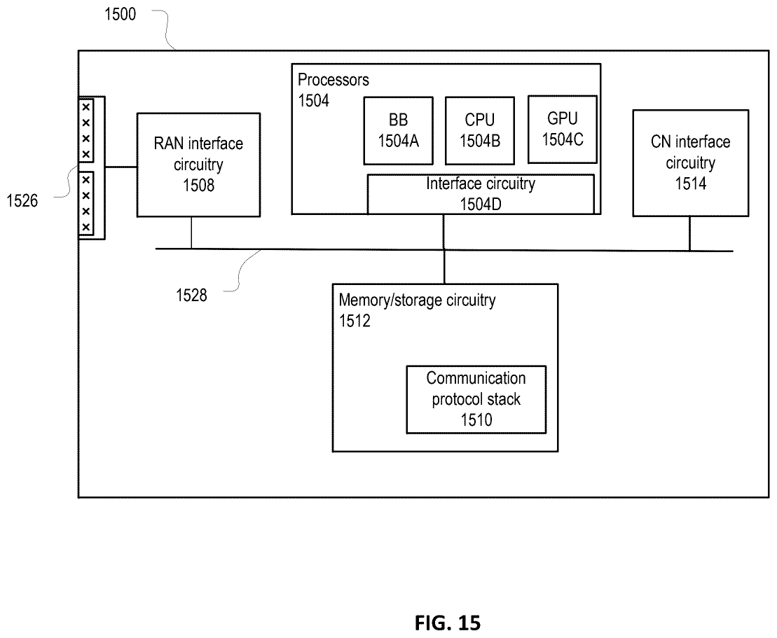

FIG. 15 illustrates a network device 1500 in accordance with some embodiments. The network device 1500 may be similar to and substantially interchangeable with base station or a device of the core network or external data network.

The network device 1500 may include processors 1504, RF interface circuitry 1508 (if implemented as a base station), core network (CN) interface circuitry 1514, memory/storage circuitry 1512, and antenna structure 1526.

The components of the network device 1500 may be coupled with various other components over one or more interconnects 1528.

The processors 1504, RF interface circuitry 1508, memory/storage circuitry 1512 (including communication protocol stack 1510), antenna structure 1526, and interconnects 1528 may be similar to like-named elements shown and described with respect to FIG. 14.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage circuitry 1512 to cause the network device to perform delay-adaptive operations as described herein. The processors 1504 may also include interface circuitry 1504D to communicatively couple the processor circuitry with one or more other components of the network device 1500.

The CN interface circuitry 1514 may provide connectivity to a core network, for example, a 5th Generation Core network (5GC) using a 5GC-compatible network interface protocol such as carrier Ethernet protocols, or some other suitable protocol. Network connectivity may be provided to/from the network device 1500 via a fiber optic or wireless backhaul. The CN interface circuitry 1514 may include one or more dedicated processors or FPGAs to communicate using one or more of the aforementioned protocols. In some implementations, the CN interface circuitry 1514 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further example embodiments are provided.
Example 1 can include a method comprising: processing information indicating a first transmission power used to transmit a first random access channel (RACH) preamble to a base station, the first RACH preamble associated with a first subscriber identity model (SIM) of a device; determining whether to use a second transmission power for transmitting a second RACH preamble or using an initial transmission power, the second RACH preamble associated with a second SIM of the device, the second transmission power based on the first transmission power, and the initial transmission power based on a path loss estimate associated with the second SIM; and determining to use the second transmission power for transmitting the second RACH preamble to the base station based on processing the information.
Example 2 can include the method of example 1, wherein determining the second transmission power comprises: determining an offset associated with transmitting the second RACH preamble; and reducing the first transmission power by the offset to determine the second transmission power.
Example 3 can include the method of any of examples 1 or 2, wherein the method further comprises: transmitting the second RACH preamble to a base station to join a network; determining that the second RACH preamble was unsuccessful; determining an offset associated with transmitting the second RACH preamble; and determining a third transmission power based on increasing the first transmission power by the offset associated, the third transmission power associated with a third RACH preamble.
Example 4 can include the method of any of examples 1-3, wherein the method further comprises: determining that the first transmission power is a maximum transmission power for transmitting the first RACH preamble, wherein the second transmission power is set to be equal to the first transmission power based on determining that the first transmission power is the maximum transmission power for transmitting the first RACH preamble.
Example 5 can include the method of any of examples 1-4, wherein the method further comprises: transmitting the second RACH preamble based on the second transmission power.
Example 6 can include the method of any of examples 1-5, wherein the method further comprises: determining a path loss estimate based on a downlink reference signal from a base station; comparing the path loss estimate to a threshold path loss estimate; and determining an offset based on comparing the path loss estimate to the threshold path loss estimate, wherein the second transmission power is based on the offset.
Example 7 can include the method of any of examples 1-6, wherein the first SIM is associated with a same operator as the second SIM.
Example 8 can include the method of any of examples 1-7, wherein the method further comprises: determining whether a frequency band used to transmit the first RACH preamble is a same frequency band as to be used to transmit the second RACH preamble; determining an offset based on whether a frequency band used to transmit the first RACH preamble is a same frequency band as to be used to transmit the second RACH preamble, wherein the second transmission power is based on the offset.
Example 9 can include an apparatus comprising: processing circuitry configured to perform any of the steps of examples 1-8; and memory coupled to the processing circuitry, the memory configured to store transmission power information.
Example 10 can include one or more non-transitory computer-readable media having stored thereon a sequence of instructions which, when executed by one or more processors, cause processing circuitry to perform any of the steps of examples 1-8.
Example 11 can include an apparatus comprising: processing circuitry configured to: process information indicating a first transmission power used to transmit a first random access channel (RACH) preamble to a base station shared by a first operator and a second operator, the first RACH preamble associated with a first subscriber identity model (SIM), and determine a second transmission power for transmitting a second RACH preamble to the base station, the second RACH associated with a second SIM based on the first transmission power, the first SIM associated with the first operator and the second SIM associated with the second operator; and memory coupled to the processing circuitry, the memory configured to store transmission power information.
Example 12 can include the apparatus of example 11, wherein the processing circuitry is further configured to: determine whether to use a second transmission power for transmitting the second RACH preamble or using an initial transmission power, wherein the second transmission power is based on the first transmission power, and the initial transmission power based on a path loss estimate associated with the second SIM.
Example 13 can include the apparatus of any of examples 11 or 12, wherein the second transmission power being greater than an initial RACH preamble transmission power associated with the second SIM.
Example 14 can include the apparatus of any of examples 11-13, wherein the processing circuitry is further configured to: process a system information block (SIB) transmitted by the base station; determine that the base station is shared by the first operator and the second operator based on processing the SIB, wherein the determining the second transmission power based on determining that the base station is shared by the first operator and the second operator.
Example 15 can include the apparatus of example 14, wherein processing the SIB transmitted by the base station comprises: determining whether a public land mobile network (PLMN)-identityInfoList indicates more than one PLMN.
Example 16 can include the apparatus of any of examples 11-15, wherein the processing circuitry is further configured to: determine a path loss estimate based on a downlink reference signal from a base station, the path loss estimate associated with the second SIM; compare the path loss estimate to a threshold path loss estimate; and determine an offset based on comparing the path loss estimate to the threshold path loss estimate, wherein the second transmission power is based on the offset.
Example 17 can include the apparatus of any of examples 11-16, wherein the processing circuitry is further configured to: determine that the first transmission power is a maximum transmission power for transmitting the first RACH preamble, wherein the second transmission power is set to be equal the first transmission power based on determining that the first transmission power is the maximum transmission power for transmitting the first RACH preamble.
Example 18 can include the apparatus of any of examples 11-17, wherein the apparatus uses a two-step RACH procedure, and wherein the processing circuitry is further configured to: determine the second transmission power based on a P_MsgA_Actual message.
Example 19 can include a method for performing any of the steps of examples 11-17.
Example 20 can include one or more non-transitory computer-readable media having stored thereon a sequence of instructions which, when executed by one or more processors, cause processing circuitry to perform any of the steps of examples 11-17.
Example 21 can include one or more non-transitory computer-readable media having stored thereon a sequence of instructions which, when executed by one or more processors, cause processing circuitry to: process information indicating a first transmission power used to transmit a first random access channel (RACH) preamble to a base station, the first RACH preamble associated with a first subscriber identity model (SIM) of a device; determine to transmit a second RACH preamble to the base station, the second RACH preamble associated with a second SIM; and determine to use a second transmission power for transmitting the second RACH preamble, the second RACH preamble associated with a second SIM of the device, the second transmission power less than or equal to the first transmission power.
Example 22 can include the one or more non-transitory computer-readable media of example 21, wherein the sequence of instructions which, when executed by one or more processors, cause processing circuitry to: determine whether the first transmission power is a maximum transmission power; and determine whether to use an offset based on whether the first transmission power is the maximum transmission power.
Example 23 can include the one or more non-transitory computer-readable media of any of examples 21 or 22, wherein the first transmission power is not the maximum transmission power, and wherein the sequence of instructions which, when executed by one or more processors, cause processing circuitry to: determine an offset associated with transmitting the second RACH preamble based on the first transmission power not being the maximum transmission power; and determine the second transmission power based on reducing the first transmission power by the offset.
Example 24 can include the one or more non-transitory computer-readable media of any of examples 21-23, wherein the first transmission power is the maximum transmission power, and wherein the sequence of instructions which, when executed by one or more processors, cause processing circuitry to: determine the second transmission power to be equal to the maximum transmission power based on the first transmission power being the maximum transmission power.
Example 25 can include a method for performing any of the steps of examples 21-24.
Example 26 can include an apparatus comprising: processing circuitry configured to perform any of the steps of examples 21-24; and memory coupled to the processing circuitry, the memory configured to store transmission power information.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing information indicating a first transmission power used to transmit a first random access channel (RACH) preamble to a base station, the first RACH preamble associated with a first subscriber identity model (SIM) of a device;
determining whether to use a second transmission power for transmitting a second RACH preamble or using an initial transmission power, the second RACH preamble associated with a second SIM of the device, the second transmission power based on the first transmission power, and the initial transmission power based on a path loss estimate associated with the second SIM; and
determining to use the second transmission power for transmitting the second RACH preamble to the base station based on processing the information.

2. The method of claim 1, wherein determining the second transmission power comprises:
determining an offset associated with transmitting the second RACH preamble; and
reducing the first transmission power by the offset to determine the second transmission power.

3. The method of claim 1, wherein the method further comprises:
transmitting the second RACH preamble to a base station to join a network;
determining that the second RACH preamble was unsuccessful;
determining an offset associated with transmitting the second RACH preamble; and
determining a third transmission power based on increasing the first transmission power by the offset associated, the third transmission power associated with a third RACH preamble.

4. The method of claim 1, wherein the method further comprises:
determining that the first transmission power is a maximum transmission power for transmitting the first RACH preamble, wherein the second transmission power is set to be equal to the first transmission power based on determining that the first transmission power is the maximum transmission power for transmitting the first RACH preamble.

5. The method of claim 1, wherein the method further comprises:
transmitting the second RACH preamble based on the second transmission power.

6. The method of claim 1, wherein the method further comprises:
determining a path loss estimate based on a downlink reference signal from a base station;
comparing the path loss estimate to a threshold path loss estimate; and
determining an offset based on comparing the path loss estimate to the threshold path loss estimate, wherein the second transmission power is based on the offset.

7. The method of claim 1, wherein the first SIM is associated with a same operator as the second SIM.

8. The method of claim 1, wherein the method further comprises:
determining whether a frequency band used to transmit the first RACH preamble is a same frequency band as to be used to transmit the second RACH preamble; and
determining an offset based on whether a frequency band used to transmit the first RACH preamble is a same frequency band as to be used to transmit the second RACH preamble, wherein the second transmission power is based on the offset.

9. An apparatus comprising:
processing circuitry configured to:
process information indicating a first transmission power used to transmit a first random access channel (RACH) preamble to a base station shared by a first operator and a second operator, the first RACH preamble associated with a first subscriber identity model (SIM), and
determine a second transmission power for transmitting a second RACH preamble to the base station, the second RACH associated with a second SIM, the second transmission power based on the first transmission power, and the first SIM associated with the first operator and the second SIM associated with the second operator; and
memory coupled to the processing circuitry, the memory configured to store transmission power information.

10. The apparatus of claim 9, wherein the processing circuitry is further configured to:
determine whether to use the second transmission power for transmitting the second RACH preamble or using an initial transmission power, and wherein the initial transmission power is based on a path loss estimate associated with the second SIM.

11. The apparatus of claim 9, wherein the second transmission power is greater than an initial RACH preamble transmission power associated with the second SIM.

12. The apparatus of claim 9, wherein the processing circuitry is further configured to:
process a system information block (SIB) transmitted by the base station; and
determine that the base station is shared by the first operator and the second operator based on processing the SIB, wherein determining the second transmission power is based on determining that the base station is shared by the first operator and the second operator.

13. The apparatus of claim 12, wherein processing the SIB transmitted by the base station comprises:
determining whether a public land mobile network (PLMN)-identityInfoList indicates more than one PLMN.

14. The apparatus of claim 9, wherein the processing circuitry is further configured to:
determine a path loss estimate based on a downlink reference signal from a base station, the path loss estimate associated with the second SIM;
compare the path loss estimate to a threshold path loss estimate; and
determine an offset based on comparing the path loss estimate to the threshold path loss estimate, wherein the second transmission power is based on the offset.

15. The apparatus of claim 9, wherein the processing circuitry is further configured to:
determine that the first transmission power is a maximum transmission power for transmitting the first RACH preamble, wherein the second transmission power is set to be equal the first transmission power based on determining that the first transmission power is the maximum transmission power for transmitting the first RACH preamble.

16. The apparatus of claim 9, wherein the apparatus uses a two-step RACH procedure, and wherein the processing circuitry is further configured to:
determine the second transmission power based on a P_MsgA_Actual message.

17. One or more non-transitory computer-readable media having stored thereon a sequence of instructions which, when executed by one or more processors, cause processing circuitry to:
process information indicating a first transmission power used to transmit a first random access channel (RACH) preamble to a base station, the first RACH preamble associated with a first subscriber identity model (SIM) of a device;
determine to transmit a second RACH preamble to the base station, the second RACH preamble associated with a second SIM; and
determine to use a second transmission power for transmitting the second RACH preamble, the second RACH preamble associated with a second SIM of the device, the second transmission power less than or equal to the first transmission power.

18. The one or more non-transitory computer-readable media of claim 17, wherein the sequence of instructions which, when executed by one or more processors, cause processing circuitry to:
determine whether the first transmission power is a maximum transmission power; and
determine whether to use an offset based on whether the first transmission power is the maximum transmission power.

19. The one or more non-transitory computer-readable media of claim 18, wherein the first transmission power is not the maximum transmission power, and wherein the sequence of instructions which, when executed by one or more processors, cause processing circuitry to:
determine an offset associated with transmitting the second RACH preamble based on the first transmission power not being the maximum transmission power; and
determine the second transmission power based on reducing the first transmission power by the offset.

20. The one or more non-transitory computer-readable media of claim 18, wherein the first transmission power is the maximum transmission power, and wherein the sequence of instructions which, when executed by one or more processors, further cause the processing circuitry to:
determine the second transmission power to be equal to the maximum transmission power based on the first transmission power being the maximum transmission power.
